(19) United States
(12) Patent Application Publication
(10) Pub. No.: US 2019/0272046 A1
(43) Pub. Date: Sep. 5, 2019

(54) MOBILE DEVICE JOYSTICK

(71) Applicants: Michael Medina, Taoz (IL); Martin Kantor, Srigim (IL); Avri Misgav, Kefar Vradim (IL)

(72) Inventors: Michael Medina, Taoz (IL); Martin Kantor, Srigim (IL); Avri Misgav, Kefar Vradim (IL)

(21) Appl. No.: 15/911,222

(22) Filed: Mar. 5, 2018

(51) Int. Cl. G06F 3/0346; G06F 3/0338; G06F 3/0362; H04M 1/23

(52) U.S. Cl. CPC G06F 3/0346; H04M 1/233; G06F 3/0362; G06F 3/0338

(57) ABSTRACT

A device that includes a control element that has multiple degrees of freedom; a mobile device holder that is configured to control a movement of a mobile device when the mobile device is connected to the mobile device holder; and a transmission mechanism that is configured to translate a movement of the control element to a corresponding movement of at least a part of the mobile device holder.

### BACKGROUND OF THE INVENTION

On one hand, mobile devices such as mobile phones and tablets include accelerators and/or orientation sensors that may be used to control various operations by rotating or otherwise moving these mobile devices.

On the other hand, movement of the mobile by the user are inaccurate and/or tiring.

There is a growing need to control mobile device such as tablets and cellular phones in an accurate and easy manner.

### BRIEF DESCRIPTION OF THE INVENTION

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

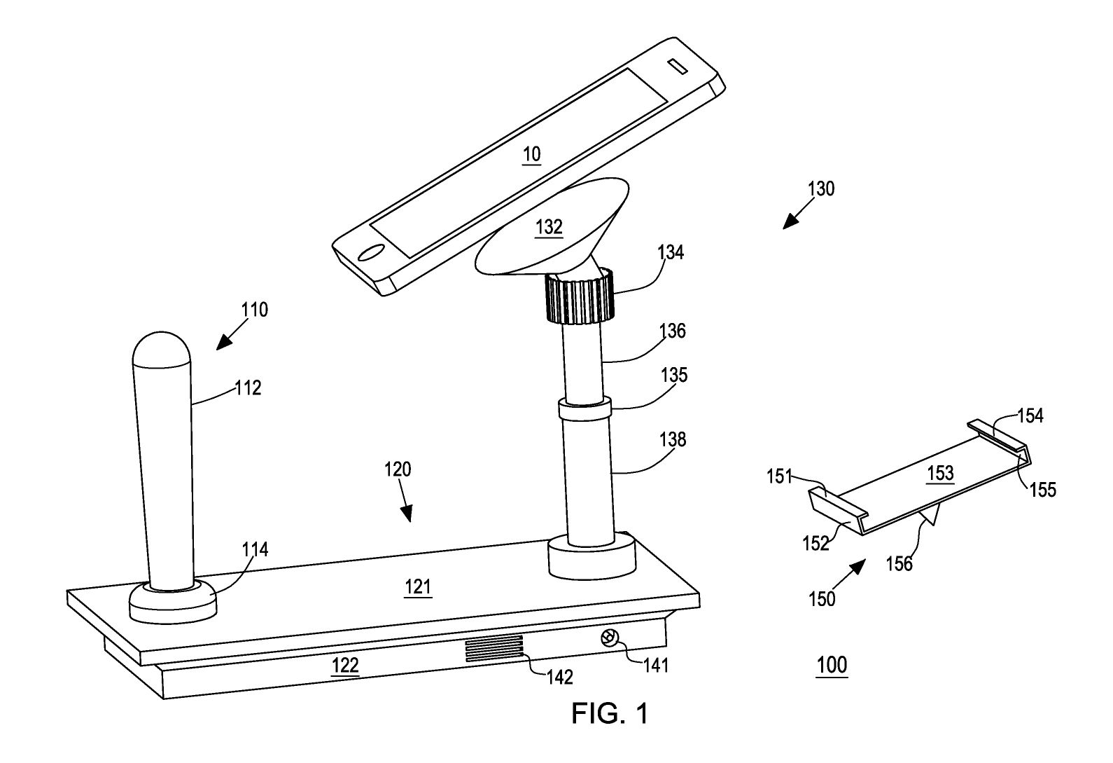

FIG. 1 illustrates an example of a device and a mobile device;

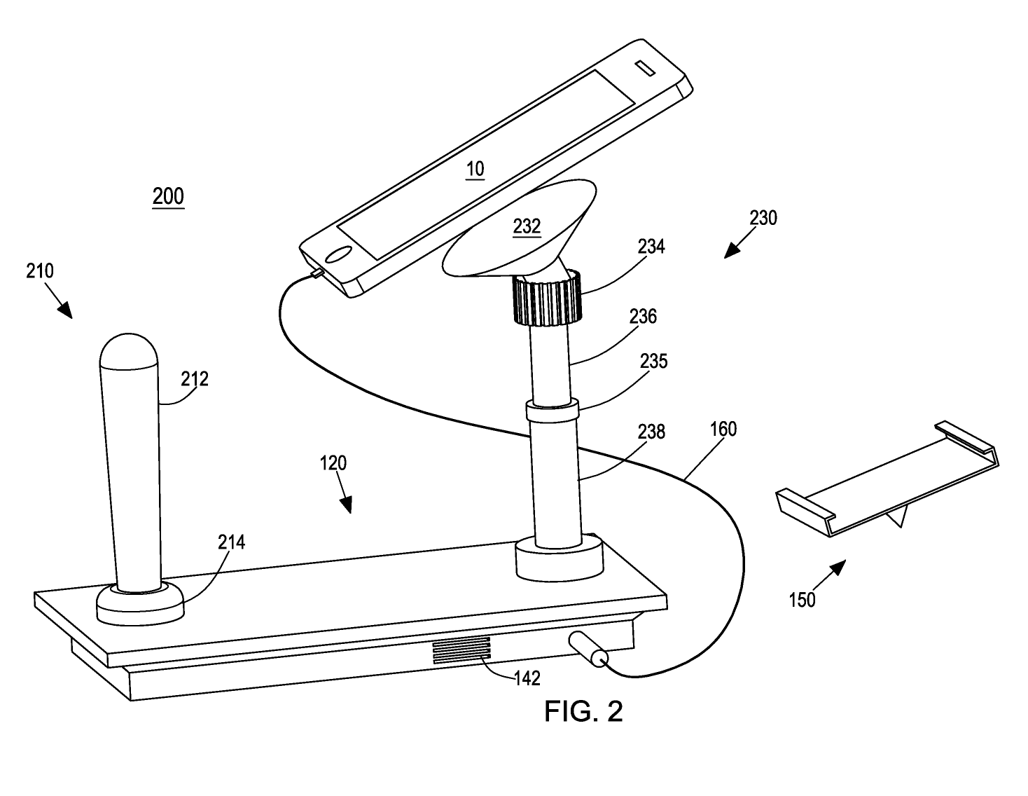

FIG. 2 illustrates an example of a device and a mobile device;

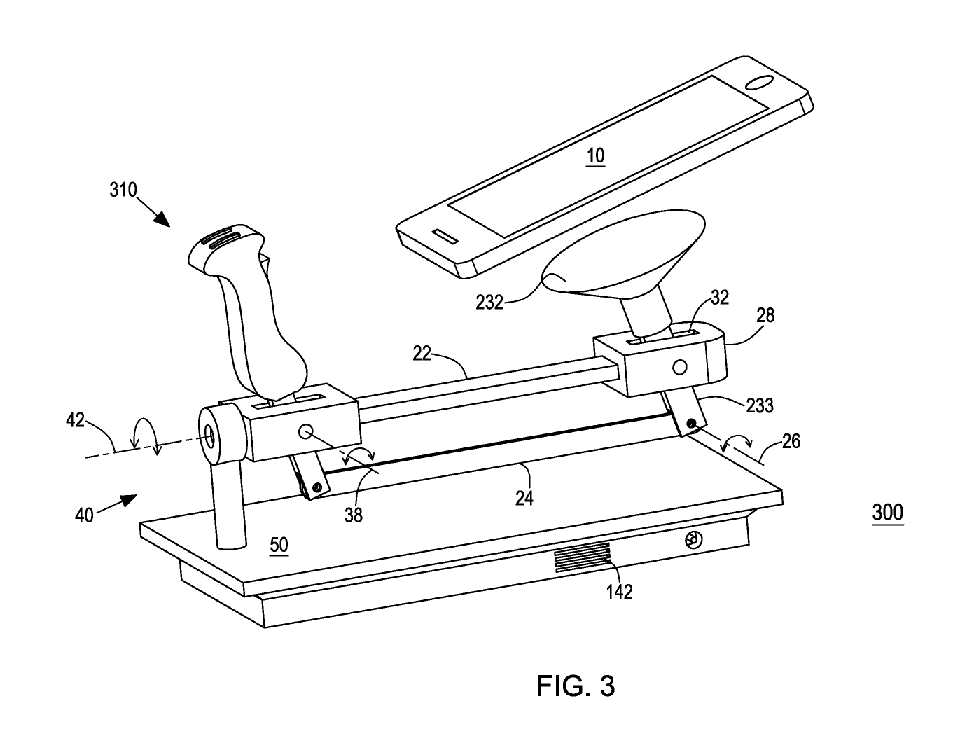

FIG. 3 illustrates an example of a device and a mobile device;

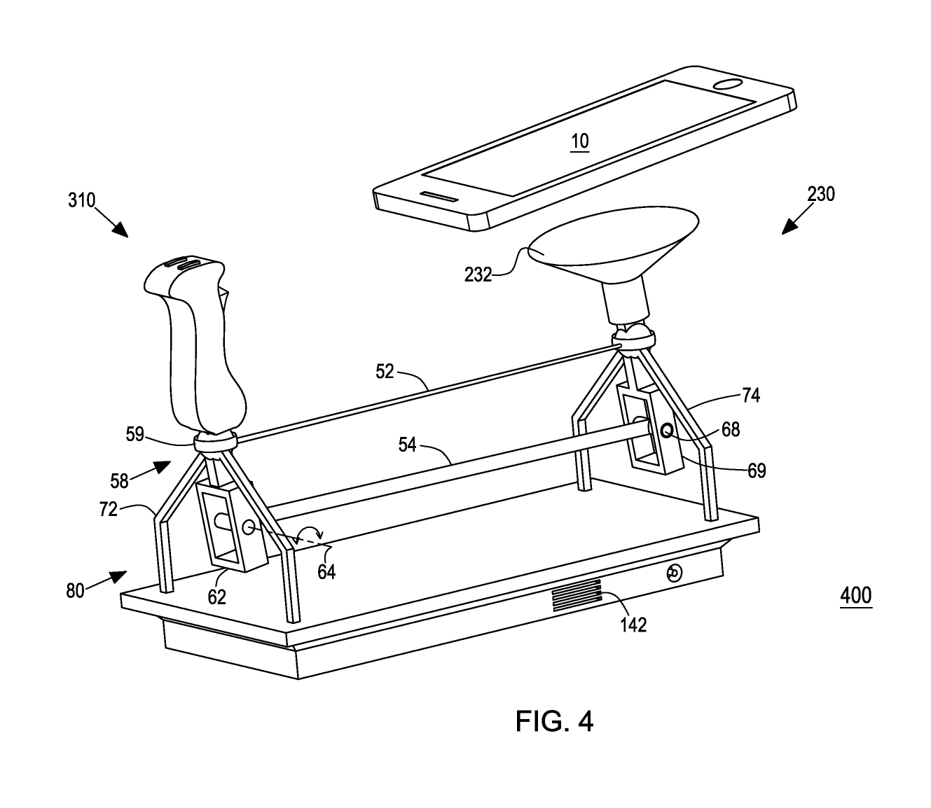

FIG. 4 illustrates an example of a device and a mobile device;

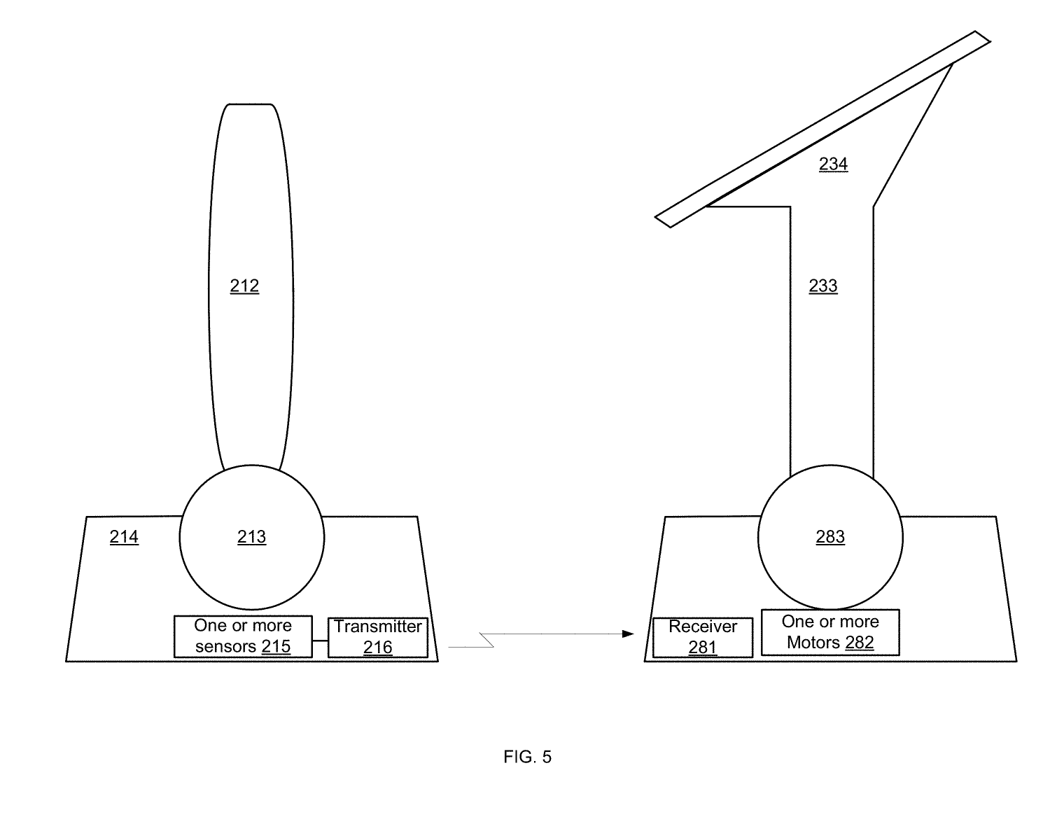

FIG. 5 illustrates an example of some parts of a device; and

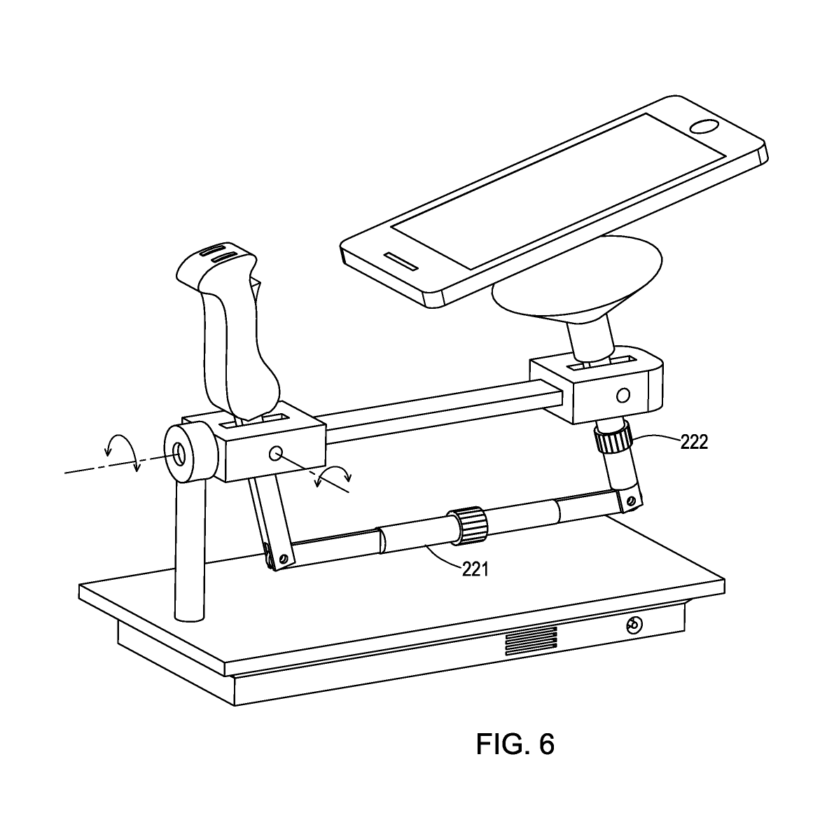

FIG. 6 illustrates an example of a device and a mobile device.

### DETAILED DESCRIPTION OF THE INVENTION

Because the apparatus implementing the present invention is, for the most part, composed of optical components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

In the following specification, the invention will be described with reference to specific examples of embodiments of the invention. It will, however, be evident that various modifications and changes may be made therein without departing from the broader spirit and scope of the invention as set forth in the appended claims.

According to an embodiment of the invention there is provided a device that includes (a) a joystick or any other type of control knob that can be contacted by a user and may have multiple degrees of freedom, (b) a mobile device holder that is configured to connect to the mobile device and support the mobile device, (c) a transmission mechanism for translating the movement of the joystick to a corresponding movement of the mobile device holder and hence to movements of the mobile device, and (d) a housing that may be provide support to at least some of the mentioned above elements.

The joystick is spaced apart from the mechanical device holder. The distance may be few centimeters.

The mobile device holder may hold the mobile in a predefined or adjustable angle in relation to the horizon. The module device, once held by the mobile device holder may face the user (that holds the joystick).

The mobile device holder may have an interfacing element (magnetic and/or mechanical for supporting the mobile device, an intermediate element (such as a rod) and a mechanical interface for interfacing with the transmission mechanism. The intermediate element may be fixed to the transmission mechanism of may me move in relation to the transmission mechanism—until it is fixed or maintained in a certain position. For example—the intermediate element may be a telescopic rod that may vertically move in relation to the transmission mechanism. The mobile device holder may include a fixing or holding elements (such as a ring, knob) that will fix the intermediate element at a desired position.

The interfacing element may provide mechanical support but may have additional functions. For example, the interfacing element may charge the mobile device (via a plug or other electrical interface or by contactless charging).

The joystick may be parallel to the intermediate element or may be oriented in relation to the intermediate element.

The mobile device may be charged by a plug that is not a part of the interfacing element.

The interfacing element may be fixed to the intermediate element but this is not necessarily so and these elements may move in relation to each other (for example by using a ball joint or any other arrangement. The movement may allow the user to adjust the spatial relationship between the device and the mobile device. The movements may be prevented during games or other tasks in which the device is used. This movement may require to apply a certain degree of force and thus the interfacing element may remain static in relation to the intermediate element during operation.

The joystick may be used for mechanical movements alone but may include additional elements such as control knobs.

The transmission mechanism may be any mechanical transmission or electrical transmission mechanism that may translate the movement of the joystick to a corresponding movement of the mobile device holder and hence to movements of the mobile device.

The transmission mechanism may translate the mechanical movement of the joystick to an identical movement of the mobile device holder. Alternatively, the transmission mechanism may introduce changes between the mechanical movement of the joystick to an identical movement of the mobile device holder. For example, movements of the joystick can be amplified or attenuated.

The housing can conceal the transmission mechanism, partially conceal the transmission mechanism or not conceal the transmission mechanism.

The device may include additional elements such as electrical plugs, a speaker, a microphone and the like.

The device or at least some parts of the device can be built from modular elements such as but not limited to LEGO™ blocks.

FIG. 1 illustrates a device 100 and mobile device 10.

Device 100 is made of modular elements such as modular blocks (such as but not limited to LEGO™ blocks).

Device 100 includes joystick 110, mobile device holder 130, transmission mechanism (not shown) and housing 120.

Joystick 110 includes a movable rod 112 and base 114 that is fixed to the housing 120.

Housing 120 has a flat upper surface 121 and sidewalls such as sidewall 122. Speaker 142 and plug 141 appear in sidewall 122. Plug 141 may provide power and/or control signals to mobile device 10 via a cord (not shown).

Mobile device 10 is shown as being moved towards mobile device holder 130. The mobile device holder 130 is connected to the mobile device 10 during the operation of device 100.

Mobile device holder 130 includes an interfacing element 132, an intermediate element (includes parts 136 and 138) and a mechanical interface (not shown).

Interfacing element 132 is magnetic mobile device holder. Interfacing element 132 is mechanically coupled via ball joint 134 to telescopic intermediate element that include a movable upper part 136, a lower part 138 and a fixing element 135 for fixing the movable upper part 136 to the lower part 138 after setting the height of the movable upper part 136. The ball joint 134 may be a friction joint that does not move (introduce movement between interfacing element 132 and movable upper part 136) during movement of the mobile device holder 130—but can be moved by the user by applying force that will overcome the friction of the ball joint 134.

FIG. 1 also shows an example of a mechanical interfacing element 150—that may replace interfacing element 132. Mechanical interfacing element 150 includes a base 153 and two wings—each wing includes a vertical element 155 and 152 respectively and a horizontal element 151 and 154 respectively. The base and wings may hold a mobile device that is inserted in a space formed by the base and the wings. The mechanical interfacing element 150 may be coupled to other parts of the mobile device holder 130 (for example may be connected to a ball joint or to the intermediate element) via connector 156.

In FIG. 1 the transmission mechanism is concealed by the housing. The joystick and the mobile device holder 130 may move under the control of the user in relation to housing 120.

FIG. 2 illustrates a device 200 that is not made of modular elements and includes joystick 210 (includes movable rod 212 and base 214), housing 120, mobile device holder 230 (includes interfacing element 232, ball joint 234, upper rod 236, lower rod 138 and fixing element 235) and transmission mechanism (not shown).

FIG. 2 also shows mechanical interfacing element 150 that may replace interfacing element 232.

Housing 120 has a flat upper surface 121 and sidewalls such as sidewall 122. Speaker 142 and plug 141 appear in sidewall 122. Plug 141 may provide power and/or control signals to mobile device 10 via a cord 160.

The cord 160 may be used to supply power and may also be arranged to covey commands from the joystick (for example when the joystick has control buttons that may be pressed to generated these commands). The commands may be transmitted from the joystick to the plug 141. Alternatively, a controller of the joystick or one or more sensors may translate the pressing on the control buttons to commands).

Any of the device illustrated in FIGS. 1-5 may include a power source (such as but not limited a battery) and/or may be fed by a power source.

FIG. 3 illustrates device 300 and mobile device 10.

Device 300 includes:
a. A joystick with control buttons (joystick) 310.
b. Joystick housing 36 that includes a joystick opening 34 in which the joystick 310 may move under the control of the user,
c. First X-axis axel 42 that passes through the joystick at a first location, while allowing the joystick to rotate about the X-axis axle,
d. First Y-axis axel 42 that is coupled to the joystick housing 36 and allows the joystick housing to rotate about the first Y-axis axle 42,
e. Mobile device holder housing 28 that includes an opening 32 in which the intermediate element 233 (or other part of the mobile device holder) may move,
f. Second X-axis axel 26 that passes through the mobile device holder at a first location, while allowing the mobile device holder 230 to rotate about the second X-axis axle 26,
g. Second Y-axis axel (not shown) that is coupled to the mobile device holder housing 28 and allows the mobile device holder housing 28 to rotate about the second Y-axis axle, and
h. Two coupling rods (such as upper connecting rod 22 and lower connecting rod 24) that are connected between the joystick and the mobile device holder and cause the mobile device holder to track the movement of the joystick. The upper connecting rod 22 is positioned above the lower connecting rod 24. In FIG. 3 the upper connecting rod 22 is connected to (or passes through openings formed in) the mobile device holder housing and the joystick housing and the lower connecting rod 24 is positioned below the mobile device holder housing and the joystick housing. Any spatial relationship may exist between the upper connecting rod, the lower connecting rod, the mobile device holder housing, and the joystick housing.

The transmission mechanism of FIG. 3 includes joystick housing, upper connecting rod, the lower connecting rod, the mobile device holder housing, first and second X-axis axles, and first and second Y-axis axels.

FIG. 4 illustrates device 400 and mobile device 10.

Device 400 includes:
a. Joystick with control buttons 310.
b. Upper connecting rod 52.
c. Lower connecting rod 54.
d. Housing base 50.
e. Speaker 142.
f. Mobile device holder 230 that includes interfacing element 232, and intermediate element 233.
g. Second ball joint 66 that is connected to (or integrated with) intermediate element 233. The second ball joint 66 includes a second ball and a second socket 67. The second ball may rotate in the second socket with multiple degrees of freedom.
h. Second jig 74 that may include a pair of legs that are connected to the second socket. The second jig may be connected to (or supported by) housing base 50.
i. Second frame 69 that is connected to the second ball.
j. Second X-axis axle 68 that passes through the second frame and through one end of a lower connecting rod 54.
k. First ball joint 58 that is connected to (or integrated with) joystick 310. The first ball joint 58 includes a first ball and a first socket 59. The first ball may rotate in the first socket with multiple degrees of freedom.
l. First jig 73 that may include a pair of legs that are connected to the first socket. The first jig may be connected to (or supported by) housing base 50.
m. First frame 62 that is connected to the first ball.
n. First X-axis axle 64 that passes through the first frame and through another end of a lower connecting rod 54.

The transmission mechanism of FIG. 4 includes first and second joint balls, first and second jigs, first and second frames, first and second X-axis axles as well as upper and lower connecting rods.

FIG. 4 is an example of a device in which each one of the joystick and the mobile device holder may be connected to a ball joint that allows multiple degrees of freedom movement of each one of the joystick and the mobile device holder, wherein the joystick and the mobile device holder are further connected to each other.

The mechanical transmission mechanism may include any known combinations of rods, joints of any type, gears, elastic and non-elastic elements to mechanically coupled between the joystick and the mobile device holder.

For example, the mechanical transmission may include a universal joint that may connect between a connecting rod and a joystick or a part of the mobile device holder.

Any joystick of any of the device may or may not include control buttons.

An electrical transmission mechanism may include a mechanical element for allowing the movement of the joystick under the control of the user, a sensor (optical, pressure, force, accelerometer, magnetic, mechanical) for tracking the movement of the joystick, a motor and/or mechanical transmission for moving the mobile device holder according to movement sensed by the sensor and communication link (wired or not wider) for transmitting sensor information and/or commands responsive to the sensed movements to the motor.

FIG. 5 illustrates some parts of a device.

FIG. 5 illustrates a joystick that includes a movable rod 212 that is connected to a joystick ball joint 213. The joystick also include base 214.

One or more sensor 215 senses the movement of the joystick ball joint. Detection signals indicative of the movement of the joystick balls (or commands reflecting the sensed movement) may be transmitted by transmitter 216.

A receiver 281 receives the detection signals and/or commends and feeds them to one or more motor 282 that may rotate a mobile device holder ball joint 283 to perform a corresponding movement of the mobile device holder. The mobile device holder ball joint 283 is connected to intermediate element 233 that is connected via another ball joint 234 to the interfacing element.

Any combination of any parts of any of the devices may be provided.

According to an embodiment of the invention there may be provided a device that may include a control element that has multiple degrees of freedom; a mobile device holder that may be configured to control a movement of a mobile device when the mobile device may be connected to the mobile device holder; and a transmission mechanism that may be configured to translate a movement of the control element to a corresponding movement of at least a part of the mobile device holder.

The transmission mechanism may be configured to translate the movement of the control element to a corresponding movement of the entire mobile device holder.

The control element may be a joystick. The movement of the joystick may refer to the movement of the knob or rod or any movable part of the joystick. The joystick may include a static or dynamic base or housing.

The device may include at least one out of an electrical plug a speaker and a microphone. The electric plug may be any type of inlet and/or outlet. The electric plug may be connected to a wire that in turn may be connected to an inlet or plug of the mobile device.

The mobile device holder may include an interfacing element that may be configured to mechanically interface with the mobile device. The interfacing element may be detachably connected to the mobile device. Once connected to the interfacing element the movement of the interfacing element control the movement of the mobile device. The mobile device may follow the movements of the interfacing elements.

The interfacing element can interface directly or indirectly with the mobile device. For example, the interfacing element may be connected to a jacket and/or cover and/or charging element that is attached to the mobile device.

The control element may be spaced apart from the mobile device holder. The distance between the control element and the mobile device holder may be fixed or may be changed.

For example, the housing may include different parts that may be moved in relation to the other while the control element and the mobile device holder may be connected to different parts of the housing. The housing may be a telescopic housing. Parts of the housing may slide in relation to each other, may rotate in relation to each other and the like. The change of distance may require using a transmission mechanism that adjusts to these movements. Referring to FIG. 6, the upper connecting rod, the lower connecting rod can be of adjustable length (for example may have a telescopic structure—be first and second telescopic rods 221 and 222). The transmission mechanism and the housing may have fixing elements (such as rings, knobs) for fixing their relative position once the distance between control element and the mobile device holder is set.

The distance between the control element and the mobile holder may be few centimeters such as between 4 and 30 centimeters.

The control element may be parallel to the mobile device holder. Alternatively, the control element may be oriented (by any angle between 1 and 359 degrees) in relation to the mobile device holder.

The mobile device holder (when static) may be configured to hold the mobile device in a predefined orientation in relation to the horizon. Thus, the interfacing element can be oriented in a certain orientation.

Alternatively—the mobile device holder when static may be configured to hold the mobile device in an adjustable orientation in relation to the horizon. For example, referring to FIG. 1 the interfacing element may be rotated by the user to determine the orientation of the mobile device.

The mobile device holder may be configured to hold the mobile device so that the mobile device faces the control element. Thus, when the user holds the control element the mobile device may face the user.

The mobile device holder may include an interfacing element for supporting the mobile device, a mechanical interface for interfacing with the transmission mechanism and an intermediate element that may be positioned below the interfacing element.

The interfacing element may be a magnetic interfacing element that may be configured to be magnetically coupled to the mobile device.

The interfacing element may be a mechanical interfacing element that may be configured to be mechanically coupled to the mobile device.

The intermediate element may be fixed to the mechanical interface.

The intermediate element may be configured to move in relation to the mechanical interface. For example—the intermediate element may be a telescopic element.

The device may include a holding element for holding the intermediate element in a fixed position in relation to the mechanical interface. See, ring of knob of FIG. 3.

The interfacing element may include a charging element for electrically charging the mobile device. The charging element may be a plug or any other wired charging element that is connected via wire (or may include the wire) that is also connected to the mobile device.

The charging element may be a contactless charging element. The contactless charging element may be included in the interfacing element. The mobile device includes another contactless charging element. When the mobile device is connected to the interfacing element the two contactless charging elements are electromagnetically coupled to each other.

The interfacing element may be fixed to the intermediate element.

The interfacing element may be movably coupled to the intermediate element.

The interfacing element may be coupled to the intermediate element via a joint.

The joint may be a friction joint that maintains static during movement of the mobile device holder.

The joystick may include non-mechanical control knobs that once pressed generate a command.

The transmission mechanism may be a mechanical transmission mechanism.

The transmission mechanism may be an electrical transmission mechanism.

The transmission mechanism may include at least one sensor for tracking a movement of the control element; a mobile device movement module for moving the at least portion of the mobile device holder; and a communication module (such as a communication link, a receiver and a transmitter) for transmission of at least one of sensor information and commands responsive to sensed movement to the mobile device movement module.

The mobile device movement module may include a motor and a mechanical transmission element.

The at least one sensor may include an optical sensor, a pressure sensor, a force sensor, an accelerator, a magnetic sensor, a mechanical sensor.

The transmission mechanism may be configured to translate the movement of the control element so that the movement of the control element is identical to the corresponding movement of the at least part of the mobile device holder.

The transmission mechanism may be configured to translate the movement of the control element so that the movement of the control element differs to the corresponding movement of the at least part of the mobile device holder.

The transmission mechanism may be configured to translate the movement of the control element so as to amplify the movement of the control element. Thus, a certain movement of the control element is translated to a larger movement of the at least part of the mobile device.

The transmission mechanism may be configured to translate the movement of the control element so as to attenuate the movement of the control element. Thus, a certain movement of the control element is translated to a smaller movement of the at least part of the mobile device.

The device may include a housing the may be mechanically coupled to the control element and to the mobile device holder.

The housing may be configured to conceal the transmission mechanism.

The housing may be configured to partially conceal the transmission mechanism.

The housing may include at least one opening for at least one out of an electrical plug a speaker and a microphone.

The device may be made of modular elements. The modular elements may be modular blocks.

The transmission mechanism may include a control element housing that includes an opening that facilitates a movement of the control element under a control of a user; a first X-axis axel that passes through the control element at a first location while allowing the control element to rotate about the first X-axis axle; a first Y-axis axle that may be coupled to the control element housing and facilitates a rotation of the control element housing about the first Y-axis axle; a mobile device holder housing that may include an opening that facilitates a movement of the at least part of the mobile device holder; a second X-axis axel that passes through the mobile device holder at a first location that facilitates a rotation of the at least part of the mobile device holder about the second X-axis axle; a second Y-axis axel that may be coupled to the mobile device holder housing and facilitates a rotation of the mobile device holder housing about the second Y-axis axle; two coupling rods may be connected between the control element and the at least part of the mobile device holder and cause the at least part of the mobile device holder to track a movement of the control element.

It is noted that the X-axis and the Y-axis may be any arbitrary axes that are oriented (normal or not normal) to each other.

The control element may be a joystick.

The transmission mechanism may include a first ball joint and a second ball joint; wherein the control element may be mechanically coupled to the first ball joint; wherein the mobile device holder may be mechanically coupled to the second ball joint; wherein the control element and the mobile device holder may be mechanically coupled to each other.

The control element may be connected to the first ball joint and may be movable with multiple degrees of freedom; wherein the mobile device holder may be connected to the second ball joint and may be movable with multiple degrees of freedom; and wherein the control element and the mobile device holder may be connected to each other.

There may be provided a method for controlling a movement of a mobile device the method may include tracking a movement of a control element that may be controlled by a user; and translating by transmission mechanism a movement of the control element to a corresponding movement of at least a part of a mobile device holder that holds the mobile device thereby controlling the movement of the mobile device.

The method may be executed by any of the mentioned above devices.

For example—the tracking may be a mechanical tracking of the movements. The tracking may involve using one or more sensors.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations, and alternatives are also possible. The specifications and drawings are, accordingly, to be regarded in an illustrative rather than in a restrictive sense.

The application is not limited to 2D and may expand to 3D inspection. The inspected substrate is not limited to a wafer and may include any type of substrate, especially flat substrates such as a printer circuit board, a solar panel, a MEMS device and the like.

The word “comprising” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

We claim:

1. A device, comprising a control element that has multiple degrees of freedom; a mobile device holder that is configured to control a movement of a mobile device when the mobile device is connected to the mobile device holder; and a transmission mechanism that is configured to translate a movement of the control element to a corresponding movement of at least a part of the mobile device holder; and wherein the transmission mechanism is configured to translate the movement of the control element to a corresponding movement of the mobile device holder.

2. (canceled)

3. The device according to claim 1, wherein the control element is a joystick.

4. The device according to claim 1, comprising at least one out of an electrical plug, a speaker and a microphone; wherein the interfacing element comprises a charging element for electrically charging the mobile device.

5. The device according to claim 1, wherein the mobile device holder comprises an interfacing element that is configured to mechanically interface with the mobile device.

6. (canceled)

7. (canceled)

8. (canceled)

9. The device according to claim 1, wherein the control element is oriented in relation to the mobile device holder.

10. (canceled)

11. (canceled)

12. (canceled)

13. The device according to claim 1, wherein the mobile device holder comprises an interfacing element for supporting the mobile device, a mechanical interface for interfacing with the transmission mechanism and an intermediate element that is positioned below the interfacing element.

14. (canceled)

15. The device according to claim 13, wherein the interfacing element is a mechanical interfacing element that is configured to be mechanically coupled to the mobile device.

16. (canceled)

17. (canceled)

18. (canceled)

19. The device according to claim 13, wherein the intermediate element is a telescopic element and wherein the device comprises a holding element for holding the intermediate element in a fixed position in relation to the mechanical interface.

20. (canceled)

21. (canceled)

22. (canceled)

23. (canceled)

24. (canceled)

25. (canceled)

26. (canceled)

27. The device according to claim 1, wherein the joystick comprises non-mechanical control knobs.

28. (canceled)

29. (canceled)

30. The device according to claim 1, wherein the transmission mechanism is an electrical transmission mechanism that comprises:
at least one sensor for tracking a movement of the control element; wherein the at least one sensor comprises at least one sensor out of an optical sensor, a pressure sensor, a force sensor, an accelerometer, a magnetic sensor and a mechanical sensor;
a mobile device movement module for moving the at least portion of the mobile device holder; and
a communication module for transmission of at least one of sensor information and commands responsive to sensed movement to the mobile device movement module.

31. The device according to claim 30 wherein the mobile device movement module comprises a motor and a mechanical transmission element.

32. (canceled)

33. (canceled)

34. (canceled)

35. (canceled)

36. (canceled)

37. (canceled)

38. (canceled)

39. The device according claim 1, wherein the movement of the control element is identical to the corresponding movement of the at least part of the mobile device holder.

40. (canceled)

41. (canceled)

42. The device according to claim 1, wherein the movement of the control element differs from the corresponding movement of the at least part of the mobile device holder; and wherein the transmission mechanism is configured to attenuate the movement of the control element.

43. (canceled)

44. (canceled)

45. (canceled)

46. (canceled)

47. The device according claim 1, wherein the device is made of modular elements.

48. The device according to claim 47, wherein the modular elements are modular blocks.

49. The device according claim 1, wherein the transmission mechanism comprises:
a control element housing that includes an opening that facilitates a movement of the control element under a control of a user;
an X-axis axel that passes through the control element at a first location, while allowing the control element to rotate about the X-axis axle;
a Y-axis axle that is coupled to the control element housing and facilitates a rotation of the control element housing about the Y-axis axle;
a mobile device holder housing that comprises an opening that facilitates a movement of the at least part of the mobile device holder;
a X-axis axel that passes through the mobile device holder at a first location, that facilitates a rotation of the at least part of the mobile device holder about the X-axis axle;
a Y-axis axis that is coupled to the mobile device holder housing and facilitates a rotation of the mobile device holder housing about the Y-axis axle;
two coupling rods are connected between the control element and the at least part of the mobile device holder and cause the at least part of the mobile device holder to track a movement of the control element.

50. (canceled)

51. The device according to claim 48 wherein the at least part of the mobile device holder is the mobile device holder.

52. The device according to claim 1 wherein the transmission mechanism comprises a first ball joint and a second ball joint; wherein the control element is mechanically coupled to the first ball joint; wherein the mobile device holder is mechanically coupled to the second ball joint; wherein the control element and the mobile device holder are mechanically coupled to each other.

53. The device according to claim 51 wherein control element is connected to the first ball joint and is movable with multiple degrees of freedom; wherein the mobile device holder is connected to the second ball joint and is movable with multiple degrees of freedom; and wherein the control element and the mobile device holder are connected to each other.

54. A method for controlling a movement of a mobile device, the method comprising tracking a movement of a control element that is controlled by a user; and translating, by transmission mechanism, a movement of the control element to a corresponding movement of at least a part of a mobile device holder that holds the mobile device thereby controlling the movement of the mobile device.
